(19) United States
(12) Patent Application Publication
(10) Pub. No.: US 2008/0041328 A1
(43) Pub. Date: Feb. 21, 2008

(54) Air intake system and air intake tube

(75) Inventor: Joseph R. Granatelli, Oxnard, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Granatelli Motor Sports, Inc.

(21) Appl. No.: 11/503,001

(22) Filed: Aug. 11, 2006

(51) Int. Cl. F02M 35/10; F02M 35/02

(52) U.S. Cl. 123/184.21; 123/198 E

(57) ABSTRACT

An air intake system for an engine has an air filter, a throttle body, and a tube coupled to the air filter at a first end and the throttle body at the second end. In this regard, the air intake elbow transitions from a circular air inlet to an oval air outlet. Further, the air intake elbow redirects the airflow radially ninety degrees to connect the circular air inlet to the oval air inlet of the throttle body. Furthermore, the air intake elbow transitions in such a way as to accelerate the air through the air intake elbow and ensure that the air is delivered to the throttle body without substantial turbulence.

### BACKGROUND

Typically, an air intake system for an engine of an automobile comprises an air filter, a mass air flow sensor (MAF), and a throttle body. Air enters the air filter and flows through tubing to the throttle body.

The air filter eliminates particulate matter from the air being delivered to the throttle body before the air enters the combustion chamber of the engine. The MAF is used to determine the mass of air entering the engine, and it is usually coupled to the tubing connecting the air filter to the throttle body. In this regard, the MAF communicates with an ECU Electronic Control Module that uses the data obtained from the MAF to determine the amount of fuel to deliver to the engine.

The throttle body is typically a housing that comprises one or more valves or one or more blades. The blades open and close in order to control the amount of air that passes through the throttle body and into the engine. The blades may be controlled mechanically or electrically. If mechanically controlled, a cable couples the accelerator to the blades so that when a driver depresses the accelerator, the blades open, and when the driver releases the accelerator, the blades close. If electrically controlled, i.e., “drive-by-wire” (DBW), when the driver depresses and releases the accelerator, control logic transmits a signal to the throttle body that controls opening and closing the blades. Notably, the valves and/or blades regulate the amount of air flowing into the intake manifold of the engine based on inputs from the accelerator operated by a driver of the automobile.

### BRIEF DESCRIPTION OF THE DRAWINGS

FIG. 1 is a perspective view of an air intake system of an automobile in accordance with an exemplary embodiment of the present disclosure.

FIG. 2 depicts a perspective view of an exemplary air intake elbow of the air intake system depicted in FIG. 1.

FIG. 3 depicts a side plan view of the air intake elbow depicted in FIG. 2.

FIG. 4 depicts a cross-sectional view of the air intake elbow depicted in FIG. 2.

FIG. 5 depicts a cross-sectional view of the air intake elbow depicted in FIG. 4 further illustrating a flow of air through the air intake elbow.

### DETAILED DESCRIPTION

Embodiments of the present disclosure generally pertain to air intake systems of automobiles. In particular, an air intake system in accordance with an embodiment of the present disclosure comprises an air intake elbow that efficiently and effectively delivers air to a throttle body of an automobile engine.

In this regard, the air intake elbow transitions from a circular air inlet to an oval air outlet. Further, the air intake elbow redirects the airflow radially ninety degrees to connect the circular air inlet to the oval air inlet of the throttle body. Furthermore, the air intake elbow transitions in such a way as to accelerate the air through the air intake elbow and ensure that the air is delivered to the throttle body without substantial turbulence.

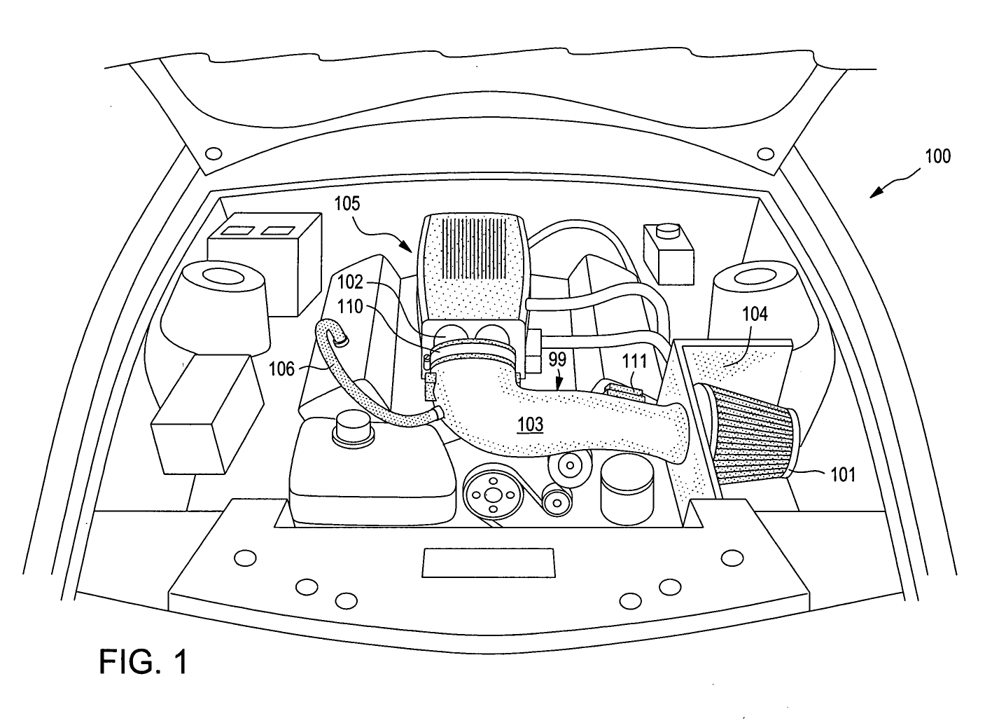

FIG. 1 depicts a perspective view of an air intake system 99 of an automobile 100. In particular, FIG. 1 depicts a footprint of a 2005 Ford Mustang that incorporates an air intake system 99 in accordance with an exemplary embodiment of the present disclosure. Note that the 2005 Ford Mustang footprint is depicted for exemplary purposes, and other types of vehicles having similar footprints may be used in other embodiments. Furthermore, for simplicity and brevity, only a portion of the parts making up the automobile 100 is shown. Indeed, other known parts may be integral with those depicted for operation of the automobile 100.

The air intake system 99 comprises an air filter 101, a throttle body 102, and an air intake elbow 103. The throttle body 102 is coupled to an engine 105, for example via a clamp 110. Notably, the air filter 101 and the throttle body 102 are coupled via the air intake elbow 103. Furthermore, the air filter 101 interfaces with the air intake elbow 103 via housing 104.

Air flows through the air filter 101 and into the throttle body 102 via the air intake elbow 103. A vacuum hose 106 is coupled to the air intake elbow 103. The vacuum hose 106 is connected to the engine 105 and circulates air and gas particles that may be emitted by the engine 105 through the air intake elbow 103 and into the throttle body 102. A set of blades (not shown) in the throttle body 102 controls the flow of the air resident in the air intake elbow 103 to the engine 105.

As described further herein, a mass air flow sensor (MAF) 111 is depicted as attached to the air intake elbow 103. The MAF 111 detects the mass of air flowing through the air intake elbow 103. Data indicative of such detection is preferably transmitted to engine control logic (not shown) that uses the data to determine the appropriate fuel mass to deliver to the engine 105.

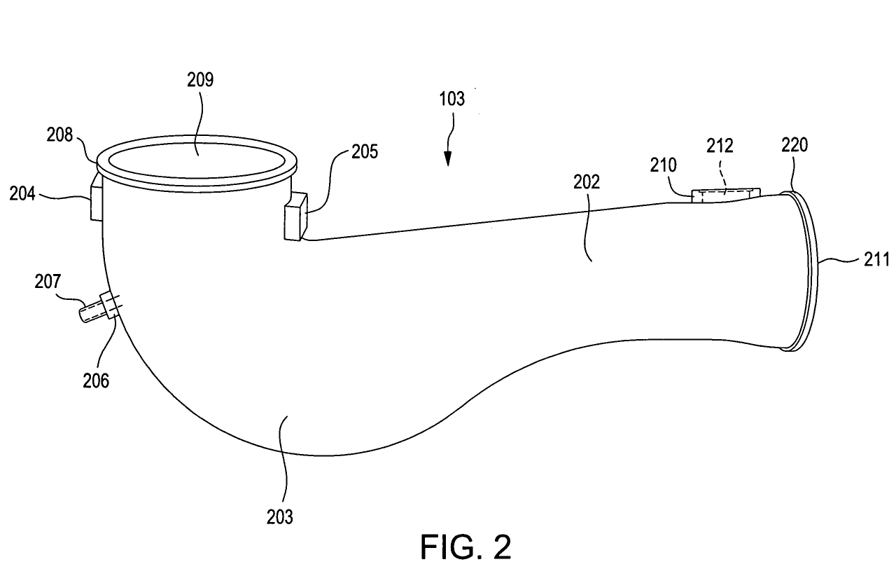

FIG. 2 depicts a perspective view of the air intake elbow 103 depicted in FIG. 1. The air intake elbow 103 has an air filter inlet 211 that interfaces with the air filter 101 (FIG. 1). In one embodiment, the air filter inlet 211 has a lip 220 that is used to secure the air filter housing 104 to the air filter inlet 211 and the air filter 101, for example via a clamp (not shown).

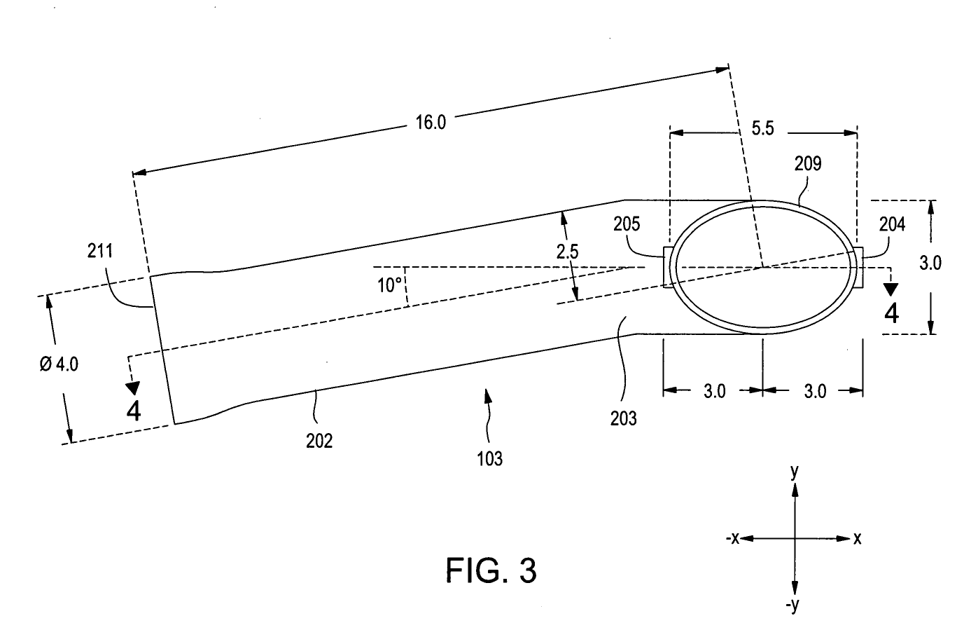

The air intake elbow 103 has a portion 202, which directs the incoming air to an elbow portion 203. Notably, the portion 202 has a substantially constant diameter, as described in more detail with reference to FIG. 3.

However, the elbow portion 203 exhibits a varying radial diameter. The elbow portion 203 varies the diameter from the portion 202 such that the throttle body outlet 209 exhibits a shape and diameter conducive to coupling to the throttle body 102 (FIG. 1).

Notably, the varying radial diameter of the elbow portion 203 directs the air out through the throttle body outlet 209. The smooth radial ninety-degree transition to the throttle body outlet 209 ensures that turbulence is not created as the direction of the air traveling through the elbow 103 changes.

The throttle body outlet 209 further has a rim 208. The rim 208 allows the clamp 110 (FIG. 1) to couple the elbow 103 to the throttle body 102 (FIG. 1).

A nipple 207 is secured to the air intake elbow 103 via a receptacle 206. The nipple 207 preferably receives the vacuum hose 106 (FIG. 1) that circulates a mixture of gases and air from the engine 105.

The air intake elbow 103 further has one or more metal protrusions, hereinafter referred to as bungs 204 and 205. Each bung 204 and 205 is unitary with the air intake elbow 103. The bungs 204 and 205 allow a user (not shown) to machine an opening (not shown) for interfacing with, for example, a nitrous supply for cold air injection.

Furthermore, the air intake elbow 103 has a mass air flow sensor-mounting protrusion 210. In this regard, the mass air flow sensor 111 (FIG. 1) can be inserted into a slot 212 formed by the mounting protrusion 210. As described hereinabove, the mass air flow sensor 111 is used to detect the air mass flowing through the air intake elbow 103. This information is communicated to control logic (not shown), which controls the valve (not shown) in the throttle body 102 (FIG. 1).

Note that the air intake elbow 103 is preferably composed of a metal material, e.g., aluminum. Furthermore, in one embodiment, such elbow 103 may be manufactured using rapid manufacturing methods wherein a casting is generated for the part and a plurality of the elbows 103 may be created using the generated casting.

FIG. 3 depicts a top plan view of the air intake elbow 103 depicted in FIG. 2. In this regard, the air filter inlet 211 is circular and exhibits a diameter of 4.0 inches. Furthermore, the throttle body outlet 209 is oval-shaped in order to interface with the throttle body 102 (FIG. 102) and exhibits a diameter of 5.5 inches across the longest portion of the oval shape and 3.0 inches across the shortest portion of the oval shape. Thus, the elbow 103 transitions from the circular air filter inlet 211 to the oval throttle body outlet 209.

The portion 202 further angles approximately ten degrees (10°) from the x-axis in the negative-y direction off center from the throttle body outlet 209. Such angle ensures correct alignment with the air filter 101 and the throttle body 102 when the elbow 103 is installed.

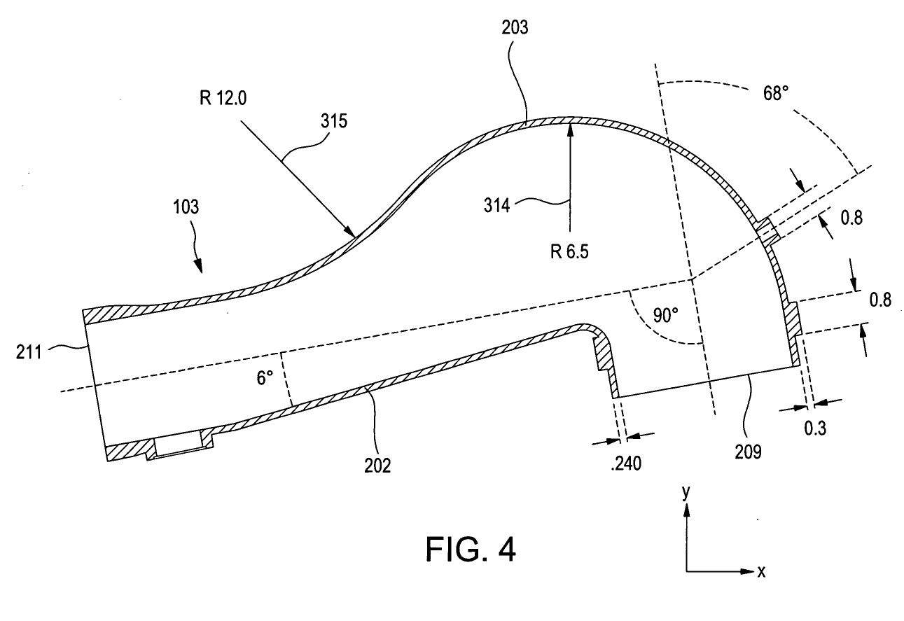

FIG. 4 depicts a cross-sectional plan view of the air intake elbow 103 depicted in FIG. 2. Notably, the portion 202 transitions radially to the elbow portion 203 and exhibits a radius of 12 inches as it axially transitions, as indicated by reference arrow 315. As the elbow 103 radially turns the ninety-degree turn to the throttle body outlet 209, the turn exhibits a radius of 6.5 inches, as indicated by reference arrow 314.

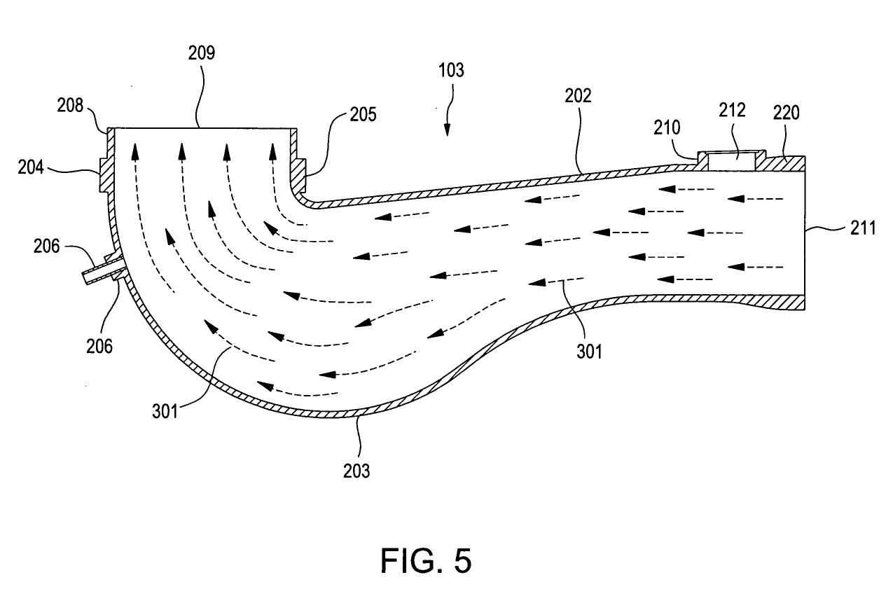

FIG. 5 depicts a cross-sectional plan view of the air intake elbow 103. Notably, air flows through the air intake elbow 103 as indicated by the reference arrows 301. In particular, air enters the air filter inlet 211 and travels through the substantially constant diameter portion 202. Note that the portion 202 may exhibit a slight angle as the elbow 103 begins to turn ninety degrees to meet the throttle body outlet 209.

As the air moves into the elbow portion 203 and makes the ninety-degree turn toward the throttle body outlet 209, the diameter of the elbow 103 increases. Therefore, the ninety-degree turn of the air moving through the elbow does not occur abruptly, but radially and gradually along the radius of the elbow portion 203.

Increasing the diameter of the elbow portion 203 and transitioning gradually to the ninety-degree turn mitigates, if not eliminates turbulence that may occur if the angular transition was abrupt, e.g., an immediate ninety-degree turn of the air. If the angle did not radially transition, then stacking of the air would occur and decrease the acceleration and/or velocity of the air flowing through the elbow 103.

As described herein, the throttle body 102 preferably comprises one or more blades that are opened and closed in accordance with the driver's actuation of the accelerator. Mitigating and/or eliminating any turbulence present in the air that is provided to these opening and/or closing blades ensures that the air that flows into the throttle body 102 (FIG. 2) flows consistently through these blades. Thus, the air is consistently provided to the throttle body 102 and improves performance.

This disclosure describes the invention in detail using illustrative embodiments. However, the invention defined by the appended claims is not limited to the precise embodiments described.

1. An air intake system for an engine, comprising:
an air filter;
a throttle body; and
a tube having a first end and a second end, the first end coupled to the air filter and the second end coupled to the throttle body, an outlet of the air filter and an inlet of the throttle body positioned at an angle one from the other, an inner surface of the tube having a substantially constant diameter at the first end and radially extending with a varying diameter at a bend in the tube such that air flows through the tube into the throttle body without stacking, wherein the varying diameter is greater than the constant diameter.

2. The air intake system as claimed in claim 1, wherein the angle is ninety degrees.

3. (canceled)

4. The system of claim 1, wherein the bend exhibits a radius of 6.5 inches.

5. The system of claim 1, wherein the tube further has at least one bung for receiving a nitrous connection.

6. The system of claim 1, wherein the tube further comprises a mass air flow sensor-mounting protrusion positioned to receive a mass air flow sensor.

7. An air intake elbow, comprising:
an air inlet through which air from an air filter is received;
an air outlet through which air to a throttle body is passed, the air inlet and the air outlet angularly positioned with respect to each other; and
a tube configured to direct air from the air inlet to the air outlet such that turbulence within the tube is mitigated, the tube having an inner surface radially extending with a varying diameter at a bend in the tube, wherein the varying diameter is greater than a diameter of the inner surface at the air inlet.

8. The air intake elbow of claim 7, wherein the air inlet is circular.

9. The air intake elbow of claim 8, wherein the air outlet is oval.

10. The air intake elbow of claim 9, wherein the air inlet is positioned substantially ninety degrees from the air outlet.

11-15. (canceled)

16. The air intake elbow of claim 15, wherein the varying diameter radially extends about a 6.5 inch radius.

17. The air intake system as claimed in claim 1, wherein the bend exhibits a radius of 6.5 inches, and wherein the substantially constant diameter is 4.0 inches.

18. The air intake system as claimed in claim 17, wherein a portion of the inner surface forming the bend slopes about 6 degrees with respect to a centerline of the tube at the first end where the tube has a substantially constant diameter.

19. The air intake system as claimed in claim 18, wherein the inner surface at the second end forms an oval having a maximum diameter of about 5 inches and a minimum diameter of about 2.5 inches.

20. The air intake elbow of claim 16, wherein the diameter of the inner surface at the inlet is 4.0 inches.

21. The air intake elbow of claim 20, wherein a portion of the inner surface forming the bend slopes about 6 degrees with respect to a centerline of the tube at the inlet.
